(19) United States
(12) Patent Application Publication
(10) Pub. No.: US 2026/0087821 A1
(43) Pub. Date: Mar. 26, 2026

(54) MONITORING DEVICE, MONITORING METHOD, AND NON-TRANSITORY COMPUTER-READABLE MEDIUM

(71) Applicant: NEC Corporation, Tokyo (JP)

(72) Inventors: Yoshimasa ONO, Tokyo (JP); Junichi ABE, Tokyo (JP); Hidemi NOGUCHI, Tokyo (JP); Tatsuya FUJIMOTO, Tokyo (JP)

(73) Assignee: NEC Corporation, Tokyo (JP)

(21) Appl. No.: 19/321,508

(22) Filed: Sep. 8, 2025

(30) Foreign Application Priority Data
Sep. 25, 2024 (JP) 2024-165896

(51) Int. Cl. G06V 20/54; G01B 11/24; G01S 17/894; G06V 10/60; G08G 1/16

(52) U.S. Cl. CPC G06V 20/54; G01B 11/24; G01S 17/894; G06V 10/60; G08G 1/164

(57) ABSTRACT

A monitoring device according to the present disclosure includes a division unit for dividing a three-dimensional space indicating point cloud data into at least one divided space, an observation unit for observing a feature amount of first point cloud data included in the divided space in a reference period and observing a feature amount of second point cloud data included in the divided space in an observation period, and a determination unit for determining, as an abnormal state, a first divided space in which a time during which a difference between the feature amount of the second point cloud data and the feature amount of the first point cloud data exceeds a first threshold value is longer than a second threshold value, in which the first divided space is included in the at least one divided space.

### INCORPORATION BY REFERENCE

This application is based upon and claims the benefit of priority from Japanese patent application No. 2024-165896, filed on Sep. 25, 2024, the disclosure of which is incorporated herein in its entirety by reference.

### TECHNICAL FIELD

The present disclosure relates to a monitoring device, a monitoring method, and a program.

### BACKGROUND ART

In order to achieve automatic driving of a vehicle, a traffic control system that utilizes information detected by a sensor installed on a road side has been studied. As travel assistance achieved by the traffic control system, detection of a foreign substance or a falling object on a road is assumed. Specifically, in a case where a foreign substance or a falling object on a road is detected, the traffic control system provides detected information to a vehicle traveling on the road.

WO 2016/002776 A1 discloses a configuration example of a monitoring device capable of recognizing an object. The monitoring device disclosed in WO 2016/002776 A1 distinguishes and recognizes an object and a background of the object from a measurement result of a three-dimensional laser scanner that measures a monitoring region.

### SUMMARY

In a traffic control system, it is required to detect an object in a three-dimensional space. However, in WO 2016/002776 A1, since the monitoring device is characterized by distinguishing the background that is the two-dimensional data and the object, there is a problem that the object existing on the background spreading in the three-dimensional space cannot be accurately recognized.

An example object of the present disclosure is to provide a monitoring device, a monitoring method, and a program capable of recognizing an object existing on a background spreading in a three-dimensional space.

A monitoring device according to an example aspect of the present disclosure includes a division unit for dividing a three-dimensional space indicating point cloud data into at least one divided space, an observation unit for observing a feature amount of first point cloud data included in the divided space in a reference period and observing a feature amount of second point cloud data included in the divided space in an observation period, and a determination unit for determining, as an abnormal state, a first divided space in which a time during which a difference between the feature amount of the second point cloud data and the feature amount of the first point cloud data exceeds a first threshold value is longer than a second threshold value, in which the first divided space is included in the at least one divided space.

A monitoring method according to an example aspect of the present disclosure includes dividing a three-dimensional space indicating point cloud data into at least one divided space, observing a feature amount of first point cloud data included in the divided space in a reference period, observing a feature amount of second point cloud data included in the divided space in an observation period, and determining, as an abnormal state, a first divided space in which a time during which a difference between the feature amount of the second point cloud data and the feature amount of the first point cloud data exceeds a first threshold value is longer than a second threshold value, the first divided space being included in the at least one divided space.

A program according to an example aspect of the present disclosure causes a computer to execute dividing a three-dimensional space indicating point cloud data into at least one divided space, observing a feature amount of first point cloud data included in the divided space in a reference period, observing a feature amount of second point cloud data included in the divided space in an observation period, and determining, as an abnormal state, a first divided space in which a time during which a difference between the feature amount of the second point cloud data and the feature amount of the first point cloud data exceeds a first threshold value is longer than a second threshold value, the first divided space being included in the at least one divided space.

According to the present disclosure, a monitoring device, a monitoring method, and a program capable of recognizing an object existing on a background spreading in a three-dimensional space can be provided.

### BRIEF DESCRIPTION OF DRAWINGS

FIG. 1 illustrates a configuration example of a monitoring device;

FIG. 2 illustrates a flow of abnormality determination processing executed in the monitoring device;

FIG. 3 illustrates the monitoring device and a vehicle traveling on a road;

FIG. 4 illustrates a configuration example of the monitoring device;

FIG. 5 is a diagram illustrating voxels set in a three-dimensional space;

FIG. 6 is a diagram illustrating voxels set in a three-dimensional space;

FIG. 7 illustrates an outline of a reference model;

FIG. 8 illustrates a change that occurred in a voxel Vi in an observation period;

FIG. 9 illustrates a flow of reference model generation processing;

FIG. 10 illustrates a flow of determination processing in the observation period; and

FIG. 11 is a block diagram illustrating a configuration example of the monitoring device.

### EXAMPLE EMBODIMENT

### First Example Embodiment

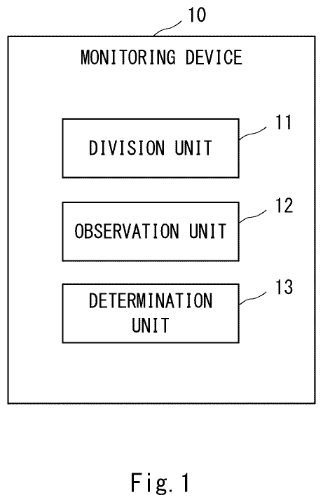

FIG. 1 illustrates a configuration example of a monitoring device 10. The monitoring device 10 may be, for example, a device that detects a foreign substance on a road by monitoring the road on which the vehicle travels. The foreign substance may include a falling object dropped from the traveling vehicle. The monitoring device 10 may be a computer device that operates in response to a processor executing a program stored in a memory.

The monitoring device 10 includes a division unit 11, an observation unit 12, and a determination unit 13. The division unit 11, the observation unit 12, and the determination unit 13 may be software or modules in which processing is executed by the processor executing a program stored in the memory. Alternatively, the division unit 11, the observation unit 12, and the determination unit 13 may be hardware such as a circuit or a chip. Although FIG. 1 illustrates an example in which the monitoring device 10 includes the division unit 11, the observation unit 12, and the determination unit 13, the division unit 11, the observation unit 12, and the determination unit 13 may be dispersedly arranged in a plurality of devices. In this case, each device may transmit and receive information via a network. That is, the monitoring system may be constructed by distributing the division unit 11, the observation unit 12, and the determination unit 13 in a plurality of devices.

The division unit 11 divides the three-dimensional space indicating point cloud data into at least one divided space. The point cloud data is a set of points having three-dimensional information. The three-dimensional information may be coordinates on an X axis, a Y axis, and a Z axis representing a three-dimensional space. The point cloud data may be generated using a sensor. For example, the point cloud data may be generated in a sensor using Light Detection and Ranging (LiDAR). Alternatively, the point cloud data may be generated by matching feature points of a plurality of pieces of image data obtained by photographing the same object from a plurality of places. The generation of the point cloud data using the plurality of pieces of image data may be performed using Structure from Motion (SfM), for example. The image data may be generated by an image capturing apparatus used as a sensor. The three-dimensional space indicating the point cloud data may be paraphrased as a three-dimensional space including the point cloud data.

The at least one divided space constitutes a three-dimensional space. That is, the three-dimensional space is constituted by a plurality of divided spaces. The three-dimensional space may be a region measured by a sensor. That is, the three-dimensional space may be a space including an object for generating the point cloud data. As the coordinates used in the three-dimensional space, for example, world coordinates may be used, or coordinates unique to the sensor may be used.

Each of the divided spaces constituting the three-dimensional space may have the same size or different sizes. The same size may mean that the divided spaces have the same shape and the same volume. The shape of the divided space may be, for example, a rectangular parallelepiped or a cube, or may be other polygons. Each divided space may be arranged so as not to overlap with other divided spaces, or may be arranged in such a way as to overlap with other divided spaces in some spaces.

For example, the division unit 11 may determine coordinates of vertices of each divided space. Alternatively, the division unit 11 may determine the coordinates of the center of the divided space and the distance from the center of the divided space to the boundary of the divided space. Furthermore, the division unit 11 may save, record, store, and the like the determined information such as coordinates of vertices of the divided space in the memory of the monitoring device 10.

The observation unit 12 observes the feature amount of the first point cloud data included in the divided space in a reference period. Furthermore, the observation unit 12 observes the feature amount of the second point cloud data included in the divided space in the observation period.

The reference period is, for example, a period during which a three-dimensional space in a normal state in which no abnormal state has occurred in the three-dimensional space is observed. The reference period may be paraphrased as, for example, a normal period, a reference period, or the like. The reference period may be, for example, a period of observing a road on which there is no traveling vehicle. That is, the reference period may be a period in which the change in the shape indicated by the point cloud data is small. The small change in the shape indicated by the point cloud data may mean that a variation in the number of point cloud data, a variation in position, or the like falls within a predetermined range. On the other hand, the observation period is a period in which the three-dimensional space is observed to determine whether an abnormal state has occurred in the three-dimensional space. The observation period may be paraphrased as a monitoring period or the like.

The feature amounts of the first point cloud data and the second point cloud data may be, for example, information related to the number of points included in the divided space. Alternatively, the feature amounts of the first point cloud data and the second point cloud data may be information related to the brightness of each point. The brightness of each point may be paraphrased as brightness associated with each point. Alternatively, the feature amounts of the first point cloud data and the second point cloud data may be information related to the normal vector of each point.

Observing the feature amounts of the first point cloud data and the second point cloud data may be paraphrased as measuring, computing, calculating, or the like the feature amounts of the first point cloud data and the second point cloud data.

The determination unit 13 determines whether the time during which the difference between the feature amount of the second point cloud data and the feature amount of the first point cloud data exceeds a first threshold value is longer than a second threshold value. The first threshold value is used to determine whether a change has occurred in the divided space observed in the observation period. The first threshold value is a value that can be compared with the feature amount of the first point cloud data and the second point cloud data. The second threshold value is used to determine whether the generated change is continued. The second threshold value indicates a time or a period during which the generated change continues.

Furthermore, the determination unit 13 determines that the first divided space in which the time during which the difference exceeds the first threshold value is longer than the second threshold value is an abnormal state. That is, the determination unit 13 specifies the first divided space among at least one divided space constituting the three-dimensional space as an abnormal state.

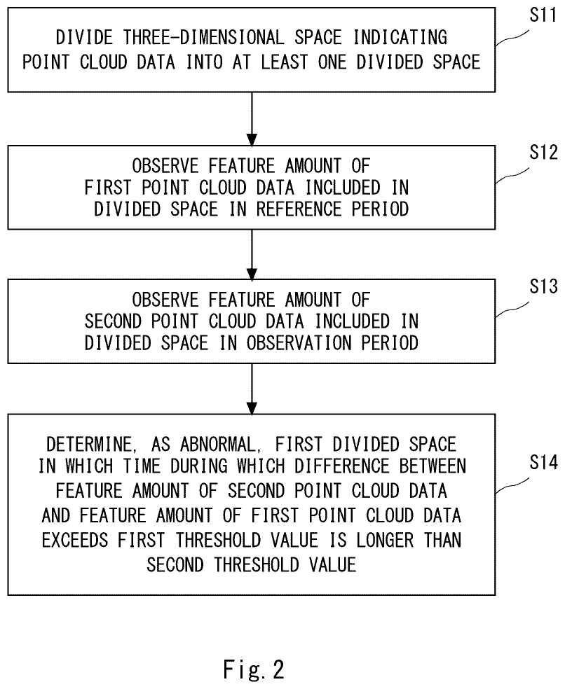

FIG. 2 illustrates a flow of abnormality determination processing executed in the monitoring device 10. First, the division unit 11 divides the three-dimensional space indicating the point cloud data into at least one divided space (S11). Next, the observation unit 12 observes the feature amount of the first point cloud data included in the divided space in the reference period (S12). Next, the observation unit 12 observes the feature amount of the second point cloud data included in the divided space in the observation period (S13). Next, the determination unit 13 determines, as an abnormal state, the first divided space in which a time during which a difference between the feature amount of the second point cloud data and the feature amount of the first point cloud data exceeds the first threshold value is longer than the second threshold value (S14).

As described above, the monitoring device 10 determines whether each divided space is in an abnormal state by comparing the feature amounts of the point cloud data in the reference period and the observation period in the divided spaces constituting the three-dimensional space. As a result, the monitoring device 10 can determine which space on the three-dimensional space is in an abnormal state.

### Second Example Embodiment

Next, processing or operation according to a second example embodiment of the present disclosure will be described. In the second example embodiment, processing in which the monitoring device 40 monitors a road and detects a foreign substance on the road will be described.

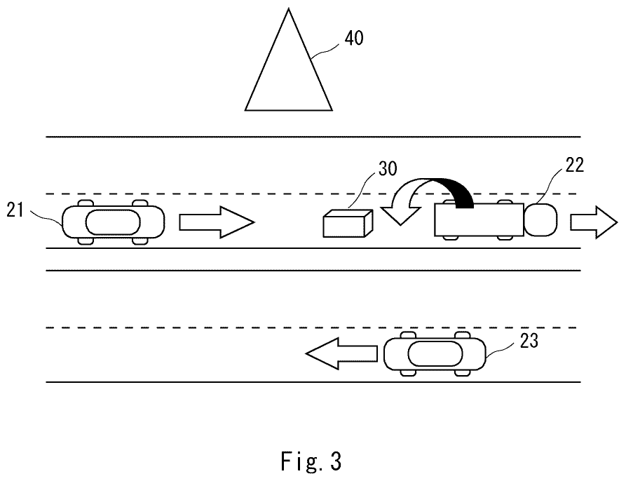

FIG. 3 illustrates the monitoring device 40 and vehicles 21 to 23 traveling on a road. It is assumed that the monitoring device 40 monitors a road in a predetermined section. FIG. 3 illustrates a state in which a package 30 has dropped from the vehicle 22. The monitoring device 40 may detect that the package 30 has dropped from the vehicle 22 or that the package 30 exists on the road, and transmit a message notifying that the package 30 exists on the road to the vehicle traveling in the section monitored by the monitoring device 40. For example, the monitoring device 40 may transmit a message over a mobile network. Alternatively, the monitoring device 40 may transmit a message using a wireless Local Area Network (LAN) or Bluetooth (registered trademark), or may transmit a message using another communication standard.

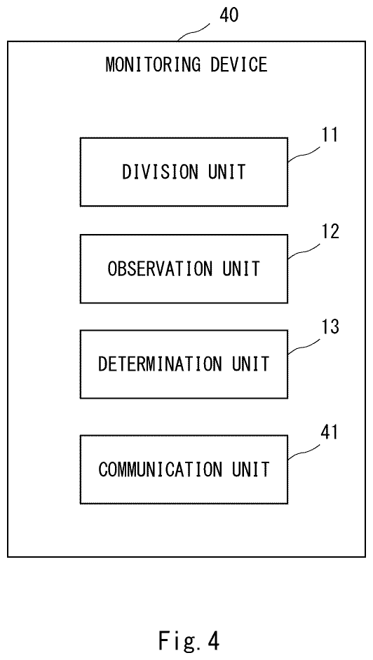

FIG. 4 illustrates a configuration example of the monitoring device 40. The monitoring device 40 has a configuration in which a communication unit 41 is added to the monitoring device 10 of FIG. 1. Hereinafter, regarding the components constituting the monitoring device 40, detailed description of functions or processing similar to those of the monitoring device 10 will be omitted.

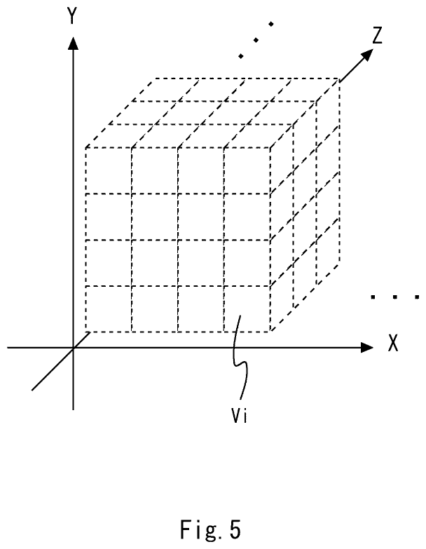

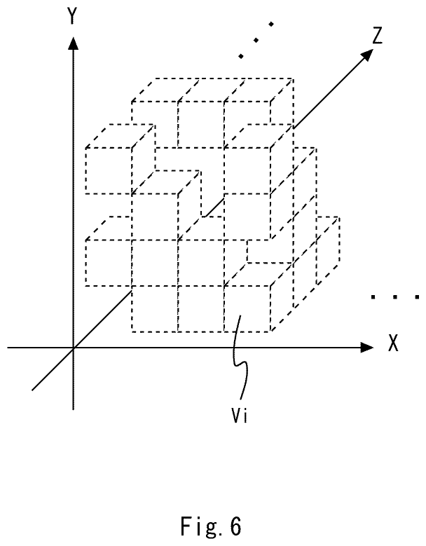

The division unit 11 of the monitoring device 40 sets a voxel as a divided space in the monitoring space. For example, as illustrated in FIG. 5, the division unit 11 may set a plurality of voxels in the monitoring space. Alternatively, as illustrated in FIG. 6, the division unit 11 may set voxels in a space where points for identifying the surface of the object, generated using LiDAR or the like, exist. That is, as illustrated in FIG. 5, the division unit 11 may set a plurality of voxels in the monitoring space before generating the point cloud data using LiDAR or the like. Alternatively, as illustrated in FIG. 6, the division unit 11 may set voxels in a space where points exist after generating the point cloud data using LiDAR or the like. As illustrated in FIGS. 5 and 6, each voxel may be set so as not to overlap other voxels, or may be set in such a way as to overlap other voxels in some space.

As illustrated in FIGS. 5 and 6, the division unit 11 may set cubes having the same size as voxels. Alternatively, the division unit 11 may set cubes or rectangular parallelepipeds having different sizes as voxels. For example, the division unit 11 may make a voxel in a place close to the monitoring device 10 larger than a voxel in a place far from the monitoring device 10. That is, the division unit 11 may make the voxel smaller as the distance from the monitoring device 10 increases. Alternatively, the division unit 11 may make the voxel smaller as the distance from a sensor that measures the point cloud data increases.

In a case where the point cloud data is generated using LiDAR, the range between beams emitted from LiDAR increases as the distance from LiDAR increases, and thus the range between points included in the point cloud data increases. That is, as the distance from the LiDAR increases, the point cloud data included in one voxel becomes sparse. Therefore, in order to increase the density of the point cloud data included in the voxel, the voxel may be made smaller as the distance from the LiDAR increases. The estimation accuracy of the object can be improved by increasing the density of the point cloud data included in the voxel.

The observation unit 12 may include a sensor for generating the point cloud data. For example, the observation unit 12 may include a LiDAR device as a sensor. That is, the LiDAR device may be mounted on the monitoring device 10. In this case, the observation unit 12 generates the point cloud data. Alternatively, the observation unit 12 may be connected to the LiDAR device installed at a position different from that of the monitoring device 10 via a network. In this case, the observation unit 12 acquires the point cloud data generated by the LiDAR device via the network. The observation unit 12 generates or acquires the point cloud data indicating an object existing in the space monitored by the monitoring device 10. In the following description, it is assumed that the observation unit 12 acquires the point cloud data generated by the LiDAR device via a network or the like.

The LiDAR device may be referred to as a laser scanner. The LiDAR device measures a distance to an object by using, for example, a Time of Flight (ToF) method, and generates point cloud data indicating a shape of the object. A set of points indicating the surface of the object is the point cloud data. The points may be specified using three-dimensional coordinates in a predetermined space.

For example, the observation unit 12 may acquire the point cloud data every predetermined period. The predetermined period may be, for example, a period such as an interval of 0.1 seconds or an interval of 0.5 seconds, and the numerical value indicating the interval is not limited to 0.1 seconds or 0.5 seconds.

The observation unit 12 may continue to acquire the point cloud data in the reference period. The observation unit 12 generates a reference model that is a model to serve as a reference in a case where a foreign substance is detected based on the point cloud data acquired in the reference period. The reference model may be referred to as a background model. The reference period is assumed to be sufficiently longer than the interval for acquiring the point cloud data.

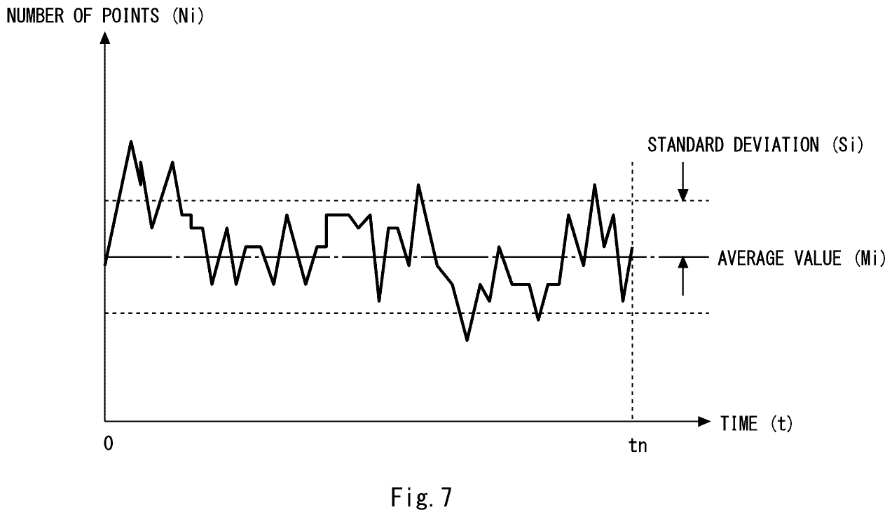

FIG. 7 illustrates an outline of the reference model. FIG. 7 illustrates a transition of the number of points in a voxel Vi that is an arbitrary voxel included in the space monitored by the monitoring device 10. For example, it is assumed that voxels V1 to Vn (1≤i≤n, i and n are positive integers) are included in the space monitored by the monitoring device 10. The number of points illustrated in FIG. 7 may indicate the number of points at the timing at which the observation unit 12 acquires the point cloud data, that is, the number of points for every predetermined period. Alternatively, the number of points illustrated in FIG. 6 may be a moving average value at a certain time. Specifically, the number of points illustrated in FIG. 6 may be an average value of the number of points within a predetermined period, such as within the past one second at a certain time. The observation unit 12 generates a reference model in each of the voxels V1 to Vn.

The voxel Vi in generating the reference model is basically a region including a stationary object. Alternatively, the voxel Vi in generating the reference model may be a region including an object whose change in shape is small over time. Here, the LiDAR device generates point cloud data by receiving a reflected beam of the emitted beam. However, the LiDAR device does not always receive the reflected beam due to the influence of atmospheric state, climate, and the like. That is, the LiDAR device receives the reflected beam of the emitted beam at a certain timing and does not receive the reflected beam at a certain timing. Therefore, as illustrated in FIG. 7, the number of points included in the voxel Vi varies depending on the timing of acquiring the point cloud data.

The observation unit 12 may calculate a value indicating a predetermined statistical spread as the statistical data related to the number of points included in the voxel Vi having a variation over time. As a value indicating the predetermined statistical spread, an average value and a standard deviation of the number of points may be calculated. Generating the reference model of the voxel Vi may be defining the average value and standard deviation of the number of points of the voxel Vi.

Furthermore, the observation unit 12 may continue to acquire the point cloud data in the observation period. The determination unit 13 determines whether an abnormality has occurred on the road based on a comparison result between the point cloud data acquired in the observation period and the reference model.

For example, the determination unit 13 determines that a change has occurred in the voxel Vi if the number of points included in the acquired point cloud data deviates from the average value of the number of points in the reference model by the standard deviation xm (m is a positive value). For example, if the voxel Vi indicates a portion on a road, determining that a change has occurred in the voxel Vi may be determining that a change has occurred on the road. Here, the observation unit 12 may use a fixed value defined in advance instead of the standard deviation. Furthermore, the determination unit 13 determines whether the generated change exceeds a duration ct1 defined in advance. In a case where the generated change exceeds the duration ct1 defined in advance, the determination unit 13 determines that the corresponding voxel is in an abnormal state.

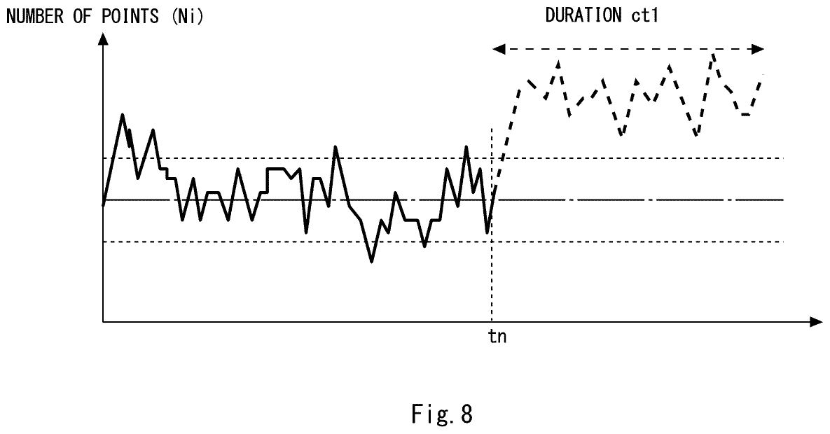

FIG. 8 illustrates that in the observation period, the change that occurred in the voxel Vi continues beyond the duration ct1. It is assumed that the observation period is a period after tn.

The state in which the change has occurred in the voxel Vi is a state in which it is estimated that a new object exists or a new object has appeared in the voxel Vi. Specifically, in a case where the change has occurred in the voxel Vi indicating a certain point on the road, it is assumed that the vehicle has passed through the voxel Vi or the package has dropped from the vehicle. Here, in a case where the vehicle passes through the voxel Vi, the change that occurred in the voxel Vi returns to the original state after a predetermined period. On the other hand, in a case where a falling object exists in the voxel Vi, the change that occurred in the voxel Vi continues even after elapse of a predetermined period. Therefore, in a case where the change that occurred in the voxel Vi continues beyond the duration ct1, the determination unit 13 may determine that a falling object exists in the voxel Vi.

The communication unit 41 transmits the determination result of the determination unit 13 to a communication device existing in a predetermined area. The determination result may include information such as the position and size of the falling object. The predetermined area may be, for example, a monitoring region of the monitoring device 40. The communication device may be, for example, a wireless communication device that enables communication via a mobile network or communication via other communication standards. The communication device may be, for example, a mobile terminal held by a person in the vehicle, or may be a device mounted on the vehicle. The device mounted on the vehicle may display the received determination result on a screen displaying an instruction of the car navigation system in cooperation with the car navigation system.

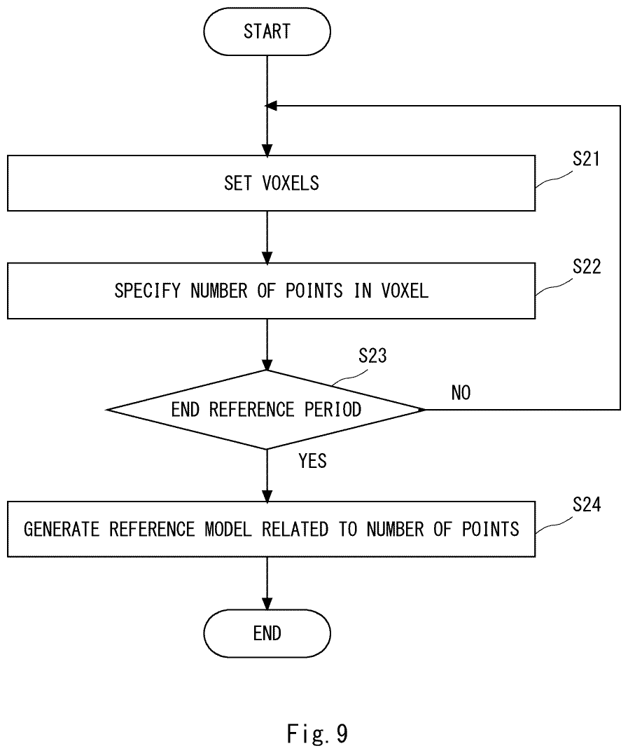

FIG. 9 illustrates a flow of reference model generation processing in the observation unit 12. First, the division unit 11 sets a voxel as a divided space in the monitoring space (S21). Here, it is assumed that the monitoring device 40 acquires the point cloud data every predetermined period. In this case, the division unit 11 may set voxels in a space where the point cloud data exists. For example, the division unit 11 may hold in advance information regarding all voxels that can be set in the monitoring space. The information regarding the voxel may be a position of the voxel, a size of the voxel, or the like. Setting a voxel may be paraphrased as enabling a voxel, determining a voxel for creating the reference model, or the like. The division unit 11 may set the voxel in such a way as to include a position where the point cloud data exists. For example, the division unit 11 may set the voxel in such a way as to include a space having a size defined in advance from the center of the point cloud data.

Next, the observation unit 12 specifies the number of points in the voxel (S22). Specifying the number of points may be paraphrased as counting the number of points, calculating the number of points, or the like. The observation unit 12 specifies the number of points in each voxel set in step S21.

Next, the observation unit 12 determines whether the reference period has ended (S23). The reference period may be defined in advance. Furthermore, the reference period may be changed by a user or the like operating the monitoring device 10 inputting information.

In a case where the observation unit 12 determines that the reference period has not ended, the processing after step S21 is repeated. In step S21, the division unit 11 may newly add a voxel in a space where the point cloud data exists to the voxels set so far.

In a case where the reference period is determined to have ended in step S23, the observation unit 12 generates the reference model based on the number of points specified in step S22 (S24). Generating the reference model may be generating statistical data related to the number of points. The reference model is generated for each voxel. The statistical data may be, for example, an average value and a standard deviation of the number of points included in the voxel Vi having a variation over time.

In step S23, it has been described that the average value of the number of points included in the point cloud data acquired every predetermined period is calculated, but the statistical data is not limited to such a value. For example, as the number of points, an average value (moving average value) of the number of points within a predetermined period such as within the past n (n is a positive integer) seconds may be used.

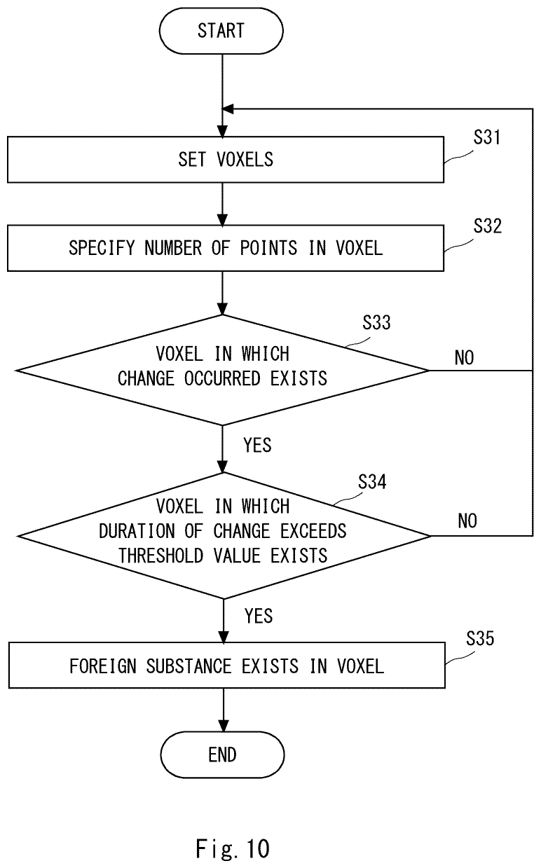

FIG. 10 illustrates a flow of determination processing in the observation period. First, the division unit 11 sets a voxel as a divided space in a space to be observed or measured as in step S21 (S31). Next, the observation unit 12 specifies the number of points in the voxel (S32). The number of points may be the number of points included in the point cloud data acquired every predetermined period, or may be an average value of the number of points within the predetermined period, such as within the past n seconds.

Next, the determination unit 13 determines whether a voxel in which a change has occurred exists (S33). For example, the determination unit 13 may determine that a change has occurred from the reference model if the number of points in the voxel specified in step S32 deviates from the average value of the number of points in the reference model by the standard deviation xm (m is a positive value).

In a case where it is determined that a voxel in which a change has occurred exists, the determination unit 13 determines whether a voxel in which the duration of the state of change exceeds a threshold value exists (S34). The duration of the state of change may be, for example, the duration of a state in which the number of points in the voxel deviates from the average value of the number of points in the reference model by the standard deviation xm (m is a positive value). The threshold value may be a duration ct1 defined in advance.

In a case where a voxel whose duration of the state of change exceeds the threshold value exists, the determination unit 13 determines that a foreign substance exists in the voxel (S35). The foreign substance may be, for example, a falling object that has fallen from a vehicle traveling on a road.

If determined in step S33 that a voxel in which a change has occurred does not exist, and if determined in step S34 that a voxel in which the duration of the state of change exceeds the threshold value does not exist, the processing after step S31 is repeated. In addition, in a case where the number of times the processing after step S31 is repeated reaches an upper limit value defined in advance, the determination processing may be ended.

As described above, the monitoring device 10 detects a change in the number of points indicating an object for every voxel that is a divided space constituting a three-dimensional space. As a result, the monitoring device 10 can detect a newly generated object on the road spreading in the three-dimensional space. Furthermore, the monitoring device 10 detects whether the duration of the state of change exceeds a threshold value. As a result, the monitoring device 10 can determine whether a newly generated object corresponds to a foreign substance on the road. As a result, the monitoring device 10 can detect a falling object that has fallen from a vehicle traveling on a road spreading in a three-dimensional space.

### Third Example Embodiment

Next, the feature amount of the point cloud data observed by the observation unit 12 will be described. In the second example embodiment, an example in which the observation unit 12 generates the reference model based on the number of points included in the point cloud data has been described, but in the third example embodiment, an example in which a feature amount different from the number of points is used will be described.

For example, brightness associated with each point may be used as the feature amount of the point cloud data. The point cloud data is generated by the LiDAR receiving a reflected beam of a beam emitted to an object. At this time, the LiDAR measures the brightness of the beam. The brightness of the beam varies depending on, for example, the material of the object from which the beam is reflected, the angle at which the beam is reflected by the object, and the like.

Therefore, the observation unit 12 may generate the reference model using the brightness of each point included in the voxel Vi. For example, the observation unit 12 may change the number of points on the vertical axis illustrated in FIG. 7 to brightness, and generate the reference model based on the variation in brightness of each point included in the voxel Vi in the reference period. Specifically, the observation unit 12 may calculate the average value and the standard deviation of the brightness of the points accumulated over time. Alternatively, the observation unit 12 may indicate the average value of the brightness of a plurality of points included in the voxel Vi on the vertical axis illustrated in FIG. 7. In this case, the observation unit 12 may use the average value of the brightness in the reference period by using the average value of the brightness of a plurality of points included in the voxel Vi every predetermined period. Alternatively, the observation unit 12 may indicate a maximum value, a minimum value, a median value, or the like among the brightness of the plurality of points included in the voxel Vi as the brightness of the voxel Vi on the vertical axis in FIG. 7.

For example, since the surface of the road and the foreign substance are different in material, the variation in brightness in the voxel Vi in a state where there is no foreign substance is different from the variation in brightness in the voxel Vi in a state where there is foreign substance. Therefore, the determination unit 13 may determine that a change has occurred in the voxel Vi in a case where the brightness of the points included in the point cloud data acquired in the observation period deviates from the average value of the brightness in the reference model by the standard deviation xm.

Furthermore, an example different from the number of points and brightness will be described as the feature amount of the point cloud data. For example, the direction of the normal vector of each point may be used as the feature amount of the point cloud data. For example, the observation unit 12 calculates the normal vector of each point included in the voxel Vi and specifies the direction of the normal vector of each point. The direction of the normal vector may be indicated by using, for example, an angle formed by a reference surface such as a ground surface and the normal vector.

The observation unit 12 may change the number of points on the vertical axis illustrated in FIG. 7 to an angle, and generate the reference model based on the variation in the angle of each point included in the voxel Vi in the reference period. Specifically, the observation unit 12 may calculate an average value and a standard deviation of angles of normal vectors of points accumulated over time. Alternatively, the observation unit 12 may indicate the average value of the angles of the normal vectors of the plurality of points included in the voxel Vi on the vertical axis illustrated in FIG. 7. In this case, the observation unit 12 may use the average value of the angles in the reference period by using the average value of the angles of a plurality of points included in the voxel Vi every predetermined period. Alternatively, the observation unit 12 may indicate a maximum value, a minimum value, a median value, or the like among the angles of the plurality of points included in the voxel Vi as the angle of the voxel Vi on the vertical axis in FIG. 7.

For example, the direction of the normal vector is different between a point indicating the surface of the road and a point indicating the foreign substance. Therefore, the determination unit 13 may determine that a change has occurred in the voxel Vi in a case where the angle of the normal vector of the point included in the point cloud data acquired in the observation period deviates from the average value of the angles in the reference model by the standard deviation xm.

As described above, the observation unit 12 can use various values other than the number of points as the feature amount. As a result, the observation unit 12 can detect an abnormal state by appropriately selecting a measurable feature amount. Alternatively, the observation unit 12 may detect an abnormal state by combining a plurality of feature amounts. As a result, the detection accuracy of the abnormal state can be improved as compared with a case of detecting the abnormal state using only one feature amount.

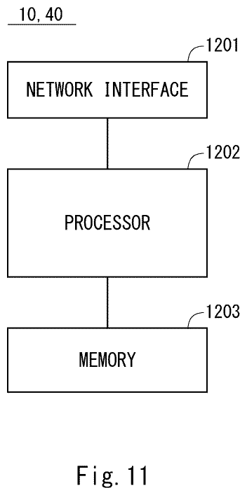

FIG. 11 is a block diagram illustrating a configuration example of the monitoring device 10 and the monitoring device 40 (hereinafter referred to as the monitoring device 10 and the like). Referring to FIG. 11, the monitoring device 10 and the like include a network interface 1201, a processor 1202, and a memory 1203. The network interface 1201 may be used to communicate with network nodes. The network interface 1201 may include, for example, a network interface card (NIC) conforming to IEEE 802.3 series. The IEEE represents the Institute of Electrical and Electronics Engineers.

The processor 1202 performs the processing of the monitoring device 10 and the like described using the flowcharts, by reading software (computer programs) from the memory 1203 and executing the software. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 via an input/output (I/O) interface (not illustrated).

In the example in FIG. 11, the memory 1203 is used to store a software module group. The processor 1202 can perform the processing in the monitoring device 10 and the like by reading the software module group from the memory 1203 and executing the software module group.

As described with reference to FIG. 11, each of the processors included in the monitoring device 10 and the like executes one or a plurality of programs including a command group for causing a computer to perform the algorithm described with reference to the drawings.

In the example described above, the program includes a group of commands (or software codes) for causing a computer to execute one or more functions described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or another memory technology, a CD-ROM, a digital versatile disc (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. As an example and not by way of limitation, transitory computer-readable or communication media include electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for describing illustrative example embodiments are not necessarily mandatory, and some features or steps may be omitted. The order of the steps described in any of the figures may be changed as appropriate.

Some or all of the example embodiments described above may be described as, but are not limited to, the following Supplementary Notes.

### (Supplementary Note 1)

A monitoring device including:
a division unit for dividing a three-dimensional space indicating point cloud data into at least one divided space,
an observation unit for observing a feature amount of first point cloud data included in the divided space in a reference period and observing a feature amount of second point cloud data included in the divided space in an observation period, and
a determination unit for determining, as an abnormal state, a first divided space in which a time during which a difference between the feature amount of the second point cloud data and the feature amount of the first point cloud data exceeds a first threshold value is longer than a second threshold value,
in which the first divided space is included in the at least one divided space.

### (Supplementary Note 2)

The monitoring device according to Supplementary Note 1, in which the feature amount is a value related to number of points included in the divided space.

### (Supplementary Note 3)

The monitoring device according to Supplementary Note 2, in which
the first threshold value is a value indicating a predetermined statistical spread of the number of points included in the divided space with respect to an elapse of time in the reference period, and
the determination unit determines, as an abnormal state, the first divided space in which a time during which the number of points exceeds a value indicating the predetermined statistical spread is longer than the second threshold value in the observation period.

### (Supplementary Note 4)

The monitoring device according to Supplementary Note 1, in which the feature amount is a value related to brightness indicated by a point included in the divided space.

### (Supplementary Note 5)

The monitoring device according to Supplementary Note 4, in which
the first threshold value is a value indicating a predetermined statistical spread of the brightness of the points included in the divided space with respect to an elapse of time in the reference period, and
the determination unit determines, as an abnormal state, the first divided space in which a time during which the brightness of the points exceeds a value indicating the predetermined statistical spread is longer than the second threshold value in the observation period.

### (Supplementary Note 6)

The monitoring device according to Supplementary Note 1, in which the feature amount is a direction of a normal vector of a point included in the divided space.

### (Supplementary Note 7)

The monitoring device according to Supplementary Note 6, in which
the first threshold value is a value indicating a predetermined statistical spread of an angle having, as a reference, a predetermined direction of a normal vector of a point included in the divided space with respect to an elapse of time in the reference period, and
the determination unit determines, as an abnormal state, the first divided space in which a time during which a value indicating an angle of a point with respect to the predetermined direction in the observation period exceeds a value indicating the predetermined statistical spread is longer than the second threshold value.

### (Supplementary Note 8)

The monitoring device according to any one of Supplementary Notes 1 to 6, in which a size of the divided space changes according to a distance from the observation unit.

### (Supplementary Note 9)

The monitoring device according to any one of Supplementary Notes 1 to 8, further including a communication unit for transmitting a determination result indicating an abnormal state to a communication device existing in a predetermined area.

### (Supplementary Note 10)

A monitoring method including:
dividing a three-dimensional space indicating point cloud data into at least one divided space,
observing a feature amount of first point cloud data included in the divided space in a reference period,
observing a feature amount of second point cloud data included in the divided space in an observation period, and
determining, as an abnormal state, a first divided space in which a time during which a difference between the feature amount of the second point cloud data and the feature amount of the first point cloud data exceeds a first threshold value is longer than a second threshold value, the first divided space being included in the at least one divided space.

### (Supplementary Note 11)

A program for causing a computer to execute:
dividing a three-dimensional space indicating point cloud data into at least one divided space,
observing a feature amount of first point cloud data included in the divided space in a reference period,
observing a feature amount of second point cloud data included in the divided space in an observation period, and
determining, as an abnormal state, a first divided space in which a time during which a difference between the feature amount of the second point cloud data and the feature amount of the first point cloud data exceeds a first threshold value is longer than a second threshold value, the first divided space being included in the at least one divided space.

Some or all of the elements (e.g., configurations and functions) described in Supplementary Notes 2 to 9 subordinate to Supplementary Note 1 may also be subordinate to Supplementary Note 10 and Supplementary Note 11 due to the subordinate relationship similar to that of Supplementary Notes 2 to 9. Some or all of the elements described in any Supplementary Note may be applied to various types of hardware, software, recording means for recording software, systems, and methods.

1. A monitoring device comprising:
at least one memory storing instructions; and
at least one processor configured to execute the instructions to:
divide a three-dimensional space indicating point cloud data into at least one divided space;
observe a feature amount of first point cloud data included in the divided space in a reference period and observing a feature amount of second point cloud data included in the divided space in an observation period; and
determine, as an abnormal state, a first divided space in which a time during which a difference between the feature amount of the second point cloud data and the feature amount of the first point cloud data exceeds a first threshold value is longer than a second threshold value,
wherein the first divided space is included in the at least one divided space.

2. The monitoring device according to claim 1, wherein the feature amount is a value related to number of points included in the divided space.

3. The monitoring device according to claim 2, wherein
the first threshold value is a value indicating a predetermined statistical spread of the number of points included in the divided space with respect to an elapse of time in the reference period; and
the at least one processor of the first base station is further configured to execute the instructions to determine, as an abnormal state, the first divided space in which a time during which the number of points exceeds a value indicating the predetermined statistical spread is longer than the second threshold value in the observation period.

4. The monitoring device according to claim 1, wherein the feature amount is a value related to brightness indicated by a point included in the divided space.

5. The monitoring device according to claim 4, wherein
the first threshold value is a value indicating a predetermined statistical spread of the brightness of the points included in the divided space with respect to an elapse of time in the reference period; and
the at least one processor of the first base station is further configured to execute the instructions to determine, as an abnormal state, the first divided space in which a time during which the brightness of the points exceeds a value indicating the predetermined statistical spread is longer than the second threshold value in the observation period.

6. The monitoring device according to claim 1, wherein the feature amount is a direction of a normal vector of a point included in the divided space.

7. The monitoring device according to claim 6, wherein
the first threshold value is a value indicating a predetermined statistical spread of an angle having, as a reference, a predetermined direction of a normal vector of a point included in the divided space with respect to an elapse of time in the reference period; and
the at least one processor of the first base station is further configured to execute the instructions to determine, as an abnormal state, the first divided space in which a time during which a value indicating an angle of a point with respect to the predetermined direction in the observation period exceeds a value indicating the predetermined statistical spread is longer than the second threshold value.

8. The monitoring device according to claim 1, wherein a size of the divided space changes according to a distance from the observation point.

9. A monitoring method comprising:
dividing a three-dimensional space indicating point cloud data into at least one divided space;
observing a feature amount of first point cloud data included in the divided space in a reference period;
observing a feature amount of second point cloud data included in the divided space in an observation period; and
determining, as an abnormal state, a first divided space in which a time during which a difference between the feature amount of the second point cloud data and the feature amount of the first point cloud data exceeds a first threshold value is longer than a second threshold value, the first divided space being included in the at least one divided space.

10. A non-transitory computer-readable medium storing a program for causing a computer to execute:
dividing a three-dimensional space indicating point cloud data into at least one divided space;
observing a feature amount of first point cloud data included in the divided space in a reference period;
observing a feature amount of second point cloud data included in the divided space in an observation period; and
determining, as an abnormal state, a first divided space in which a time during which a difference between the feature amount of the second point cloud data and the feature amount of the first point cloud data exceeds a first threshold value is longer than a second threshold value, the first divided space being included in the at least one divided space.
